(19) United States
(12) Patent Application Publication
(10) Pub. No.: US 2011/0089654 A1
(43) Pub. Date: Apr. 21, 2011

(54) MOTORCYCLE POSITIONING CREEPER

(75) Inventor: Tung-Ming CHEN, Dongguang Town (TW)

(73) Assignee: Tung-Ming Chen, Dongguang Town (TW)

(21) Appl. No.: 12/580,834

(22) Filed: Oct. 16, 2009

(51) Int. Cl. B62B 11/00; B62B 5/04

(52) U.S. Cl. 280/79.11; 280/88

(57) ABSTRACT

A motorcycle positioning creeper allows a medium to large motorcycle to be easily mounted on the positioning creeper and easily moved to any desired position on a horizontal surface. The motorcycle positioning creeper comprises an H-frame support panel and four wheels. The H-frame support panel comprises a low slung panel, four protrusions and four protrusion strengtheners. The low slung panel has a front, a rear and four corners. The protrusions are formed individually at the corners, protrude up and out and are separated from adjacent protrusions by a distance greater than a motorcycle tire width, and each protrusion has a sloped connector and a raised mounting surface. The four protrusion strengtheners are mounted respectively at the corners, and each protrusion strengthener connects to the low slung panel and the corresponding sloped connector and raised mounting surface. The four wheels are mounted rotatably respectively under the raised mounting surfaces.

### FIELD OF THE INVENTION

The invention is a motorcycle positioning creeper that allows a motorcycle to be easily mounted on the positioning creeper and easily moved to any desired position on a horizontal surface.

### BACKGROUND OF THE INVENTION

Motorcycles are important vehicles in daily life and can be roughly divided into two categories, light motorcycles and heavy motorcycles. Moving motorcycles is strenuous because motorcycles are heavy to people, especially large motorcycles.

In a motorcycle shop or showroom, heavy motorcycles must be moved and adjusted to a good exhibition position. Large motorcycles are heavy and are not easy to move into confined spaces so they must be lifted and moved with a jack or other large appliance. However, space in a heavy motorcycle shop or showroom is usually limited, and moving heavy motorcycles is inconvenient.

In addition, a person who has a car and a large motorcycle often parks the car and motorcycle in a garage. Most garages have a narrow driveway that is long enough to park a large motorcycle in front of the car. After the motorcycle is driven into the garage, the motorcycle needs to be turned around so it can be driven easily out of the garage. However, a large motorcycle is difficult to turn around because of limited space in the garage and the weight of the motorcycle.

P.R.C. Patent No. CN2238115Y published on Oct. 23, 1996, titled “Ground sliding creeper for repairing car” disclosed a creeper having a front board, a rear board, a front roller, a rear roller, two front wheels and two rear wheels. The rear board is connected to the front board. The front roller is mounted under the front board and has two ends. The rear roller is mounted under the rear board and has two ends. The two front wheels are mounted respectively on the ends of the front roller. The two rear wheels are mounted respectively on the ends of the rear roller. A person lies on the ground sliding creeper under a car and moves back and forth to a desired position to repair the car. However, the ground sliding creeper cannot be used to move a large motorcycle.

### SUMMARY OF THE INVENTION

The main objective of the present invention is to provide a motorcycle positioning creeper that allows a medium to large motorcycle to be easily mounted on the positioning creeper and easily moved to any desired position on a horizontal surface such as a showroom floor or storage area.

The motorcycle positioning creeper in accordance with the present invention comprises an H-frame support panel and four wheels. The H-frame support panel comprises a low slung panel, four protrusions and four protrusion strengtheners. The low slung panel has a front, a rear and four corners. The protrusions are formed individually at the corners, protrude up and out and are separated from adjacent protrusions by a distance greater than a motorcycle tire width, and each protrusion has a sloped connector and a raised mounting surface. The sloped connectors are formed individually on and protrude up from the corners. The raised mounting surfaces are formed individually on the sloped connectors. The four protrusion strengtheners are mounted individually at the corners, and each protrusion strengthener connects to the low slung panel and the corresponding sloped connector and raised mounting surface. The four wheels are mounted rotatably respectively under the four raised mounting surfaces.

### BRIEF DESCRIPTION OF THE DRAWINGS

FIG. 1 is a perspective view of a motorcycle positioning creeper in accordance with the present invention.

FIG. 2 is an operational perspective view of the motorcycle positioning creeper in FIG. 1.

FIG. 3 is an operational top view of the motorcycle positioning creeper in FIG. 1.

### DETAILED DESCRIPTION OF THE PRESENT INVENTION

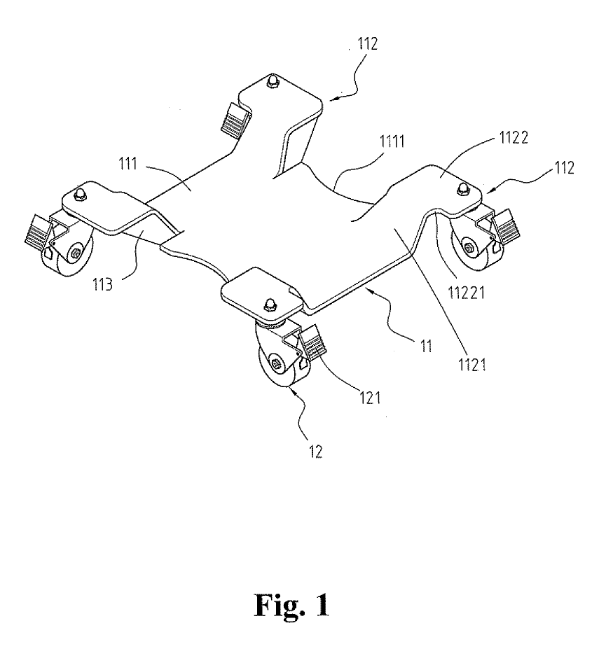

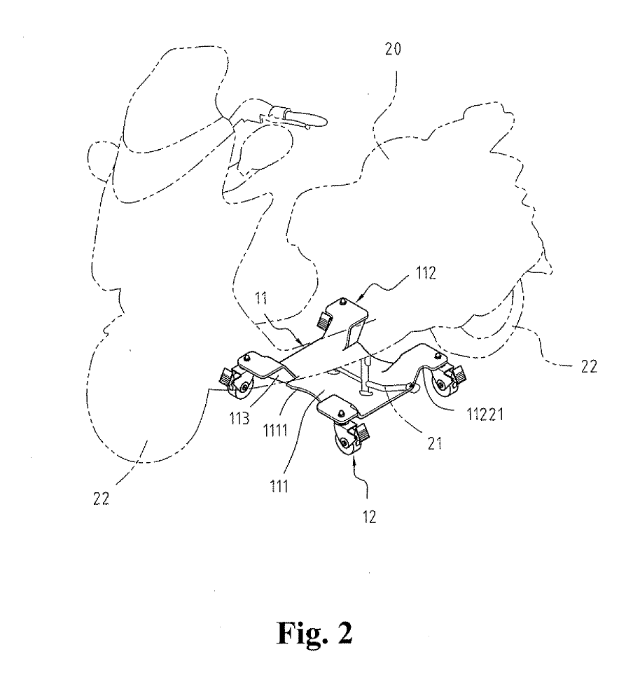

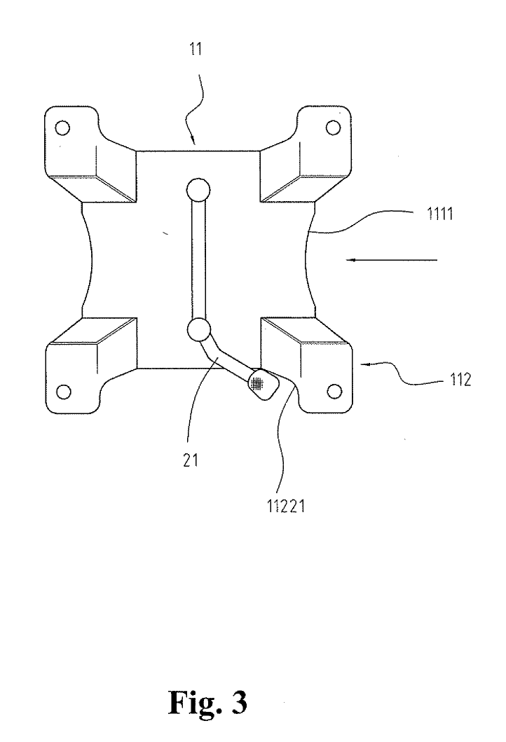

With reference to FIGS. 1, 2 and 3, a motorcycle positioning creeper in accordance with the present invention allows a motorcycle (20) with a center-stand kickstand (21) to be easily mounted on the positioning creeper and easily moved to any desired position on a horizontal surface. The motorcycle positioning creeper is mounted under the center-stand kickstand (21) and comprises an H-frame support panel (11) and four wheels (12).

The H-frame support panel (11) comprises a low slung panel (111), four protrusions (112) and four protrusion strengtheners (113).

The low slung panel (111) is rectangular and symmetrical and has a top surface, a bottom surface, two sides, a front, a rear, four corners and two optional support panel recesses (1111). The support panel recesses (1111) may be curved and are formed on the low slung panel (111) respectively at the front and rear to guide the tire onto the low slung panel (111). It is designed to minimize the cutting damages caused by moving the motorcycle onto uncurved creeper, with the curve, it will protect tires from cutting damages.

The protrusions (112) are formed individually on the corners of the low slung panel (111), protrude up and out from the corners, are separated from adjacent protrusions (112) on opposite sides by a distance greater than a motorcycle tire width so the tire can roll between protrusions (112) at the front and protrusions (112) at the rear and a center-stand kickstand or a rear wheel can be positioned on the low slung panel (111). Each protrusion (112) comprises a sloped connector (1121) and a raised mounting surface (1122).

The sloped connectors (1121) are formed individually on and protrude individually up from the corners and may protrude longitudinally or transversely. Each sloped connector (1121) has an upper end.

The raised mounting surfaces (1122) are formed individually on the upper ends of the sloped connectors (1121) and may be parallel to the low slung panel (111) and each of the raised mounting surfaces (1122) may have an interior corner (11221) that is used for the center-stand kickstand (21) being pressed downward to jack up the motorcycle.

The protrusion strengtheners (113) are mounted respectively at the corners, and each protrusion strengthener (113) connects to the low slung panel (111) and the corresponding sloped connector (1121) and raised mounting surface (1122) to keep the sloped connector (1121) and raised mounting surface (1122) from bending when supporting a motorcycle (20).

The four wheels (12) are mounted rotatably respectively under the four raised mounting surfaces (1122) so the motorcycle (20) can be easily moved in any direction to any desired position after the center-stand kickstand of the motorcycle is raised on the low slung panel (111). Furthermore, each of the wheels (12) may have an optional wheel lock (121).

A person knowledgeable in the art will understand that various changes could be made without departing from the broad spirit and scope of the invention. The above-described embodiment is intended to illustrate the present invention and not to limit the scope of the present invention.

What is claimed is:

1. A motorcycle positioning creeper allowing a motorcycle with a center-stand kickstand to be easily mounted on the positioning creeper and easily moved to any desired position on a horizontal surface, being mounted under the center-stand kickstand and comprising
an H-frame support panel comprising
a low slung panel being rectangular and symmetrical and having a top surface, a bottom surface, two sides, a front, a rear and four corners;
four protrusions being formed individually on the corners of the low slung panel, protruding up and out from the corners, being separated from adjacent longitudinal protrusions by a distance greater than a motorcycle tire width; and each protrusion comprising
a sloped connector, the sloped connectors being formed individually on and protruding up from the corners, and each sloped connector having an upper end; and
a raised mounting surface, the raised mounting surfaces being formed individually on the upper ends of the sloped connectors; and
four protrusion strengtheners being mounted respectively at the corners, and each protrusion strengthener connecting to the low slung panel and the corresponding sloped connector and raised mounting surface; and
four wheels being mounted rotatably respectively under the four raised mounting surfaces.

2. The motorcycle positioning creeper as claimed as claim 1, wherein the low slung panel further has two support panel recesses being formed on the low slung panel respectively at the front and rear.

3. The motorcycle positioning creeper as claimed as claim 1, wherein each of the wheels has a wheel lock.

4. The motorcycle positioning creeper as claimed as claim 1, wherein the raised mounting surfaces are parallel to the low slung panel.

5. The motorcycle positioning creeper as claimed as claim 1, wherein each of the raised mounting surfaces further has an interior corner.

6. The motorcycle positioning creeper as claimed as claim I, wherein the sloped connectors protrude longitudinally.

7. The motorcycle positioning creeper as claimed as claim I, wherein the sloped connectors protrude transversely.

8. The motorcycle positioning creeper as claimed as claim 2, wherein the support panel recesses are curved.
